(19) United States
(12) Patent Application Publication
(10) Pub. No.: US 2013/0283260 A1
(43) Pub. Date: Oct. 24, 2013

(54) IMAGE GUIDED METHOD FOR INSTALLING APPLICATION SOFTWARE

(71) Applicant: INSYDE SOFTWARE CORP., Taipei (TW)

(72) Inventor: I-Te CHEN, Taipei (TW)

(73) Assignee: INSYDE SOFTWARE CORP., Taipei (TW)

(21) Appl. No.: 13/859,033

(22) Filed: Apr. 9, 2013

(30) Foreign Application Priority Data
Apr. 20, 2012 (TW) 101114045

(51) Int. Cl. G06F 9/445

(52) U.S. Cl. CPC G06F 8/63
USPC 717/174

(57) ABSTRACT

An image guided method for installing application software has the steps of using an electronic device to capture an image associated with an application software (App), comparing the captured image with data in an image database, generating installing information of the App based on the comparison result, and displaying the installing information on the electronic device to guide a user to install the App in the electronic device. Therefore, when the user takes the electronic device to capture an image or an icon associated with the App, the user receives the installing information of the App through the image comparison process and installs the App in the electronic device conveniently.

### CROSS-REFERENCE TO RELATED APPLICATIONS

This application claims the benefit of Taiwan patent application No. 101114045, filed on Apr. 20, 2012, the disclosure of which is incorporated herein in its entirety by reference.

### BACKGROUND OF THE INVENTION

1. Field of the Invention

The present invention relates to a method for installing application software, and more particularly to an image guided method for installing an application software and an electronic device for executing the method.

2. Description of the Prior Art

Since the launching of smartphones in recent years, they almost act as mini computers and have powerful capacity to execute various functions. Tablet computer is another smart product that significantly changes most people's way of using typical computers. The growing popularity of smartphones and tablets among consumers owes much to application software (App) of various kinds. Up to now, more than one million kinds of applications software are available for smart devices. The application software is accessed mainly through the following ways.

1. Users can search for the application software by demand with their smartphone or the tablet computer directly. However, finding a particular application software without any guidance is difficult, which is like looking for a needle in a haystack. Even though most companies may promote their own application software on advertisement webpages, the users have to enter an on line store platform and accurately choose the application software compatible with the operating system of the smart devices.

2. The user may scan a QR code to link to a designated web page for installing the application software. However, if the application software on the web page is not compatible with the operating system of the smart devices, the user needs to do the search again.

3. Most application software may be widespread by recommendation among friends. When people try a particular application software and find it useful or interesting, they may recommend friends around to try such application software. Even users obtain information pertaining to the recommended application software, users still need to search for the application software in person.

Although a vast number of applications software have been designed and made downloadable, the current way for installing the application software is not user-friendly enough.

To overcome the shortcomings, the present invention provides an image guided method for installing application software to mitigate or obviate the aforementioned problems.

### SUMMARY OF THE INVENTION

The present invention provides an image guided method for installing application software (App), which allows a user to acquire installing information by using an electronic device to capture an image associated with the application software.

The method in accordance with a first preferred embodiment of the present invention comprises the steps of:

capturing an image associated with an application software by an electronic device;

comparing the image with data stored in an image database to obtain a comparison result;

generating installing information of the application software based on the compared result; and

displaying the installing information on the electronic device to guide an user to install the application software in the electronic device.

The image database stores data of different applications software, and the data is correlated to software installing paths. When the electronic device captures the image, the image is compared with the data in the image database. If the image matches any data, the installing information comprising the software installing path is generated. By displaying the installing information on the electronic device, the user is guided to install the application software. In other words, the user can use the smartphone or tablet computer to capture an icon, a trademark, etc so as to easily install the application software.

The method in accordance with a second preferred embodiment of the present invention is executed by a server and comprises the steps of:

receiving an image that is associated with an application software and captured by an electronic device;

comparing the image with data stored in an image database to obtain a comparison result;

generating installing information of the application software based on the comparison result; and

transmitting the installing information to the electronic device.

The present invention further provides an electronic device that executes the steps of:

capturing an image associated with an application software;

transmitting the image for comparing the image with data stored in an image database to generate a comparison result; and

receiving and displaying installing information of the application software.

In conclusion, the present invention has the features and advantages of:

1. The installation of application software is easily activated without need of searching for the application software as long as an image associated with the application software is accessible.

2. The application software can be widespread much faster among the users.

3. The comparison result can be utilized in different software platforms.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a system performing an image guided method for installing application software of the present invention;

FIGS. 2A to 2C show multiple images of application software for different operating systems;

FIGS. 3A and 3B show installing information displayed on an electronic device;

FIG. 4 is a flow chart of the image guided method for installing application software of the present invention;

FIG. 5 is a flow chart showing steps performed by a server in the present invention; and

FIG. 6 is a flow chart showing steps performed by an electronic device in the present invention.

### DETAILED DESCRIPTION OF THE PREFERRED EMBODIMENTS

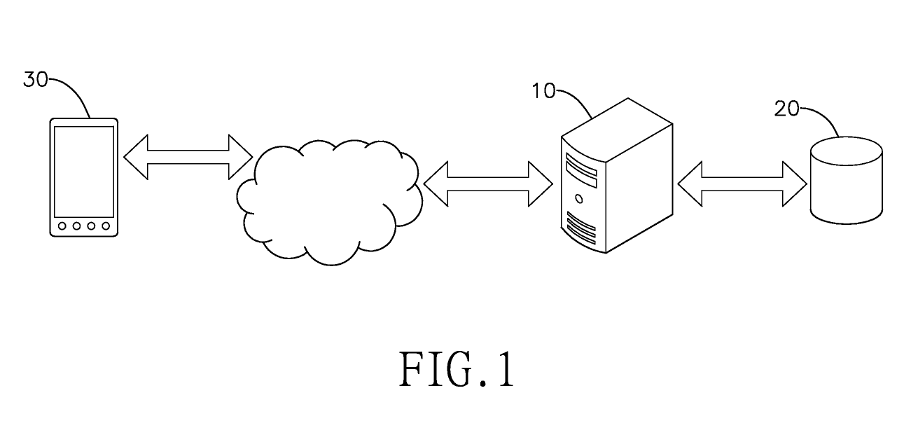

With reference to FIG. 1, a server 10 that accesses an image database 20 can link to at least one electronic device 30 through different communication protocols. The electronic device 30 has capabilities for taking photos or videos and connecting to the internet and may be, but is not limited to, a smartphone, a tablet computer, a personal digital assistance (PDA), a notebook computer, etc.

The electronic device 30 uses its photo-/video-taking function to extract an image related to an application software from the captured photo or video. The image can be an icon of the application software designed by software developing companies. Such an icon may be a pattern in a graphic user interface (GUI). The image may be shown on and accessible from the following mediums or fields.

1. A display interface of a smart device that has installed the application software, for example, display screens of the smartphones, the tablet computers, the notebook computers and the desktop personal computers.

2. Electronic medium such as a TV, a TV wall, a projector, etc.

3. Printed medium such as newspapers, magazines, advertising leaflets, flags, shop signs, etc.

When the image is shown on the electronic medium or displays, the image is preferably in a form of an icon. Thus, the electronic device 30 can capture or take a photo or video of the icon presented on the electronic medium.

After the electronic device 30 takes the photo or video, the electronic device 30 analyzes the photo or video to obtain and extract the image, and then transmits the image to the server 10 for image comparison. Alternatively, the electronic device 30 analyzes and converts the captured image to a characteristic code, and then transmits the characteristic code to the sever 10. The server 10 compares the received image or the characteristic code with data stored in the image database 20 to generate installing information of particular application software.

The server 10 has capabilities of image recognition, computation and comparison. In another embodiment, the server 10 transfers the received image to the characteristic code and then compares the characteristic code with the data in the image database 20.

The data in the image database 20 may comprise images of different applications software, characteristic codes of images of different applications software, or software installing paths corresponding to the images or corresponding to the characteristic codes. The software installing paths include, but are not limited to, webpages for installing the application software. To transfer the image to the characteristic code, the electronic device 30 or the server 10 may use the following image processing techniques.

1. Perform color separation process to obtain information of RGB, CMYK, HSV, HSL, LAB, CIELAB or CIELAB, and then analyze gray images to generate characteristic codes.

2. Before or after the color separation process, obtain edge information of the image by edge-detecting technique and generate the characteristic codes based on the edge information.

3. Use other algorithms such as binarization processing, filtering process, feature vector processing, erosion processing, dilation processing, neural system processing, etc.

In addition to the captured image provided to the server 10, the electronic device 30 may further transmit device information to the server 10 to search for the installing information of the application software that would match accurately with the user's requirements.

The device information may comprise, but is not limited to:

1. device serial number, for example, the serial numbers of the smart phones and the tablet computers;

2. device resolution, for example, the resolution of the display panel;

3. OS version, for example, the version information of Android operating system, Windows operating system, or iOS operating system;

4. registered account for the device;

5. gateway for accessing a software platform, for example, the gateway “app store” for iOS system or “Google play store” for Android system; and

6. pre-equipped peripheral elements, for example, cameras, GPS, motion sensors or microphones.

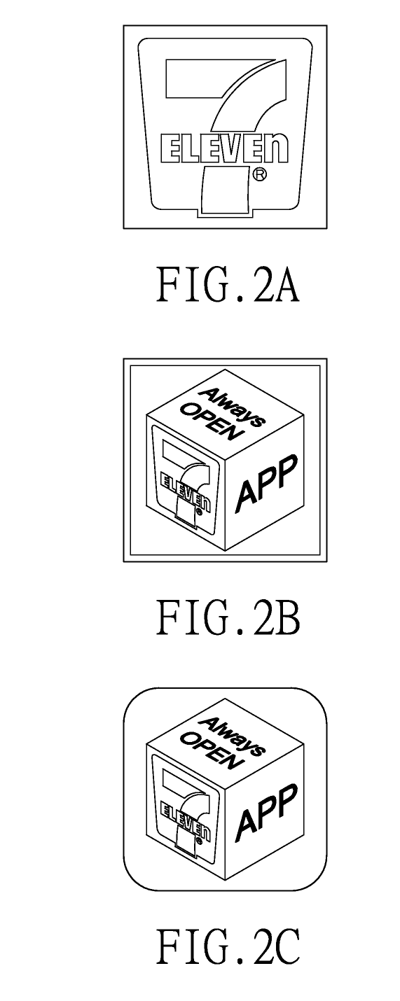

When the electronic device 30 provides any foregoing device information or combination of the information, it is helpful for the server 10 to search for the accurate installing information of the application software compatible with the electronic device 30. For example, when the electronic device 30 provides the smartphone serial number and/or the operating system version, the server 10 may exclude other incompatible application software and operating systems. With reference to FIGS. 2A to 2C, the 7-eleven Inc.® provides different icons respectively for Windows, Android, and iOS operating systems. In other words, different icons correspond to different operating systems. When the electronic device 30 captures and recognizes an icon, other icons of incompatible operating systems can be excluded. If the captured icon captured by the electronic device 30 conflicts with the electronic device 30 itself, a warning message may be generated to inform the user, or, alternatively the electronic device 30 may be guided to access the accurate icon or installing information.

If the application software to be installed is in a software platform but the electronic device 30 has no gateway for entering the software platform, gateway installing information may be provided to the electronic device 30. Therefore, the user will be required to install the gateway first, and subsequently install the application software.

When the server 10 compares the image, icon or device information provided by the electronic device 30 with the data stored in the database 20, the server 10 generates and transmits the installing information of the application software to the electronic device 30, wherein the installing information comprises at least one installing path.

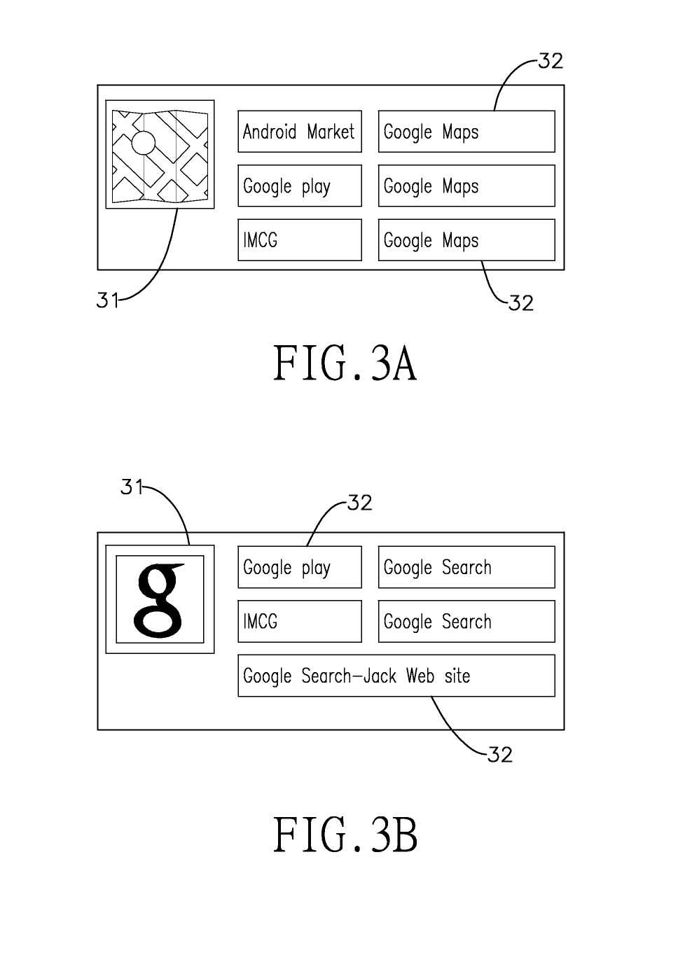

With reference to FIGS. 3A and 3B, when the installing information is transmitted to the electronic device 30, the captured icon 31 and multiple installing options 32 are displayed in a window. Each installing option 32 correlates to a link of the installing path. When the user selects and triggers one of the installing options 32, the user will be guided to a webpage for installing the application software associated with the icon.

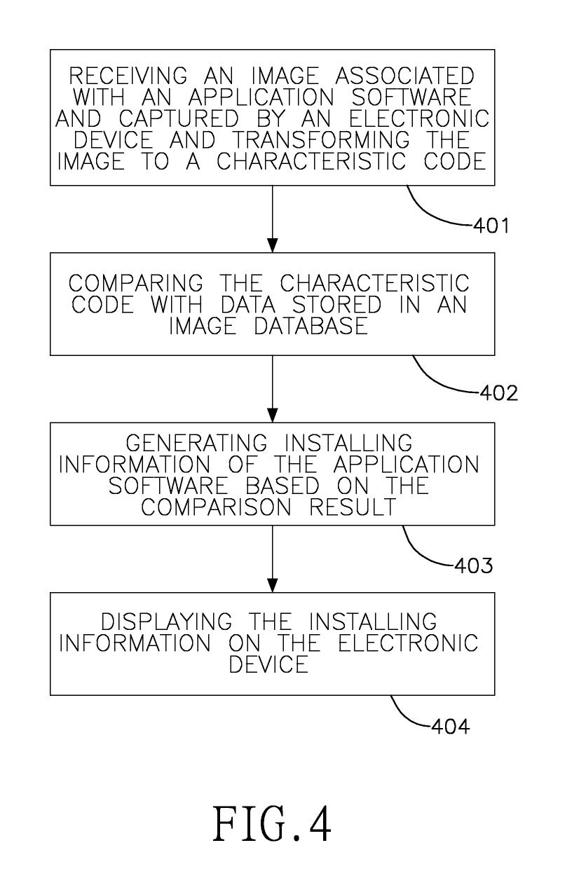

With reference to FIG. 4, based on the foregoing descriptions, the method of a first embodiment of the present invention comprises the steps of:

capturing an image associated with an application software by an electronic device 30 and transforming the image to a characteristic code (401);

comparing the characteristic code with data stored in an image database 20 to obtain a comparison result (402);

generating installing information of the application software based on the comparison result (403); and

displaying the installing information on the electronic device 30 to guide an user to install the application software in the electronic device 30 (404).

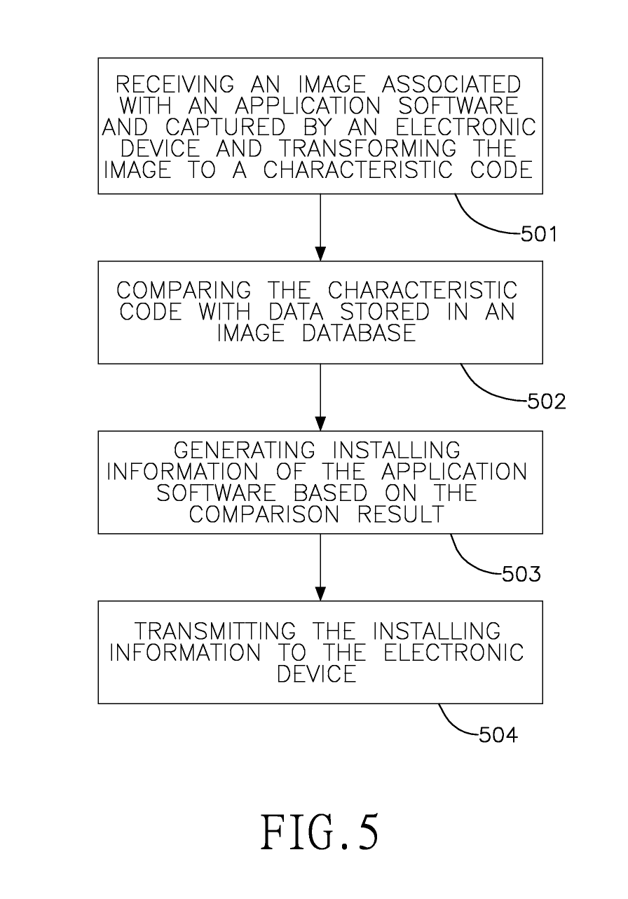

With reference to FIG. 5, in a second embodiment of the present invention, the sever 20 can execute the method having the steps of:

receiving an image associated with an application software and captured by an electronic device 30 (501);

transforming the image to a characteristic code and comparing the characteristic code with data stored in an image database 20 to obtain a comparison result (502);

generating installing information of the application software based on the comparison result (503); and

transmitting the installing information to the electronic device 30 (504).

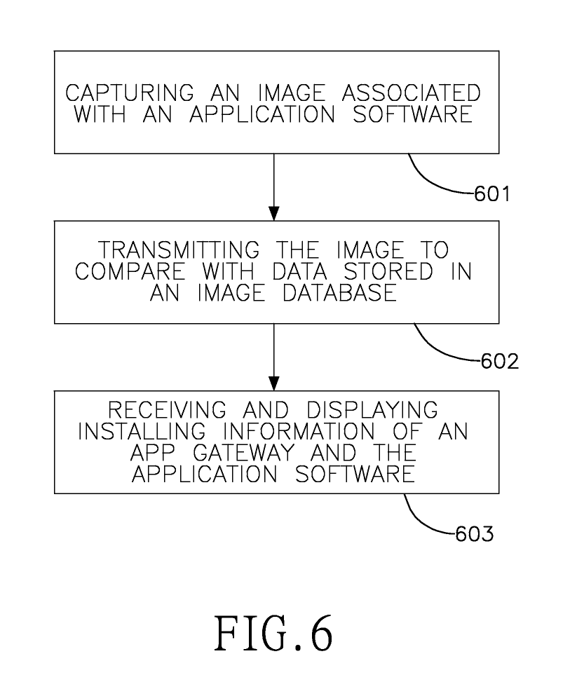

With reference to FIG. 6, in a third embodiment, the electronic device 30 executes the steps of:

capturing an image associated with an application software (601);

transmitting the image to compare with data stored in an image database 20 to generate a comparison result (602); and

receiving and displaying installing information of an App gateway and the application software, wherein the installing information is generated based on the comparison result (603).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An image guided method for installing application software, comprising the steps of:
capturing an image associated with an application software by an electronic device and transforming the image to a characteristic code;
comparing the characteristic code with data stored in an image database to obtain a comparison result;
generating installing information of the application software based on the comparison result; and
displaying the installing information on the electronic device to guide an user to install the application software in the electronic device.

2. The method as claimed in claim 1, wherein the image is obtained by analyzing a photo or video taken by the electronic device, and the image is transmitted to a server for comparing with the data in the image database.

3. The method as claimed in claim 1, wherein the image is obtained by analyzing a photo or video taken by the electronic device, and the image is converted to a characteristic code and transmitted to a server for comparing with the data in the image database.

4. The method as claimed in claim 1, wherein the image is an icon of the application software.

5. The method as claimed in claim 2, wherein the image is an icon of the application software.

6. The method as claimed in claim 3, wherein the image is an icon of the application software.

7. The method as claimed in claim 4, wherein the electronic device further provides device information comprising a serial number of the electronic device and an operating system version of the electronic device.

8. The method as claimed in claim 5, wherein the electronic device further provides device information comprising a serial number of the electronic device and an operating system version of the electronic device.

9. The method as claimed in claim 6, wherein the electronic device further provides device information comprising a serial number of the electronic device and an operating system version of the electronic device.

10. The method as claimed in claim 7, wherein the device information further comprises a resolution of the electronic device, a registered account of the electronic device, a gateway installed in the electronic device, and peripheral elements pre-equipped in the electronic device.

11. The method as claimed in claim 8, wherein the device information further comprises a resolution of the electronic device, a registered account of the electronic device, a gateway installed in the electronic device, and peripheral elements pre-equipped in the electronic device.

12. The method as claimed in claim 9, wherein the device information further comprises a resolution of the electronic device, a registered account of the electronic device, a gateway installed in the electronic device, and peripheral elements pre-equipped in the electronic device.

13. The method as claimed in claim 4, wherein the image is a pattern of a graphic user interface (GUI).

14. The method as claimed in claim 5, wherein the image is a pattern of a graphic user interface (GUI).

15. The method as claimed in claim 6, wherein the image is a pattern of a graphic user interface (GUI).

16. An image guided method for installing application software, the method executed by a server and comprising the steps of:
receiving an image that is associated with an application software and captured by an electronic device;
transforming the image to a characteristic code and comparing the characteristic code with data stored in an image database to obtain a comparison result;
generating installing information of the application software based on the comparison result; and
transmitting the installing information to the electronic device.

17. An electronic device for executing the steps of:
capturing an image associated with an application software;
transmitting the image for comparing the image with data stored in an image database to generate a comparison result; and
receiving and displaying installing information of an App gateway and the application software.

18. The electronic device as claimed in claim 17, wherein the electronic device is a smartphone, a tablet computer or a notebook computer.
